(19) United States
(12) Patent Application Publication
(10) Pub. No.: US 2011/0302849 A1
(43) Pub. Date: Dec. 15, 2011

(54) PRODUCTION OF HIGH-PURITY SUSPENSIONS CONTAINING PRECIPITATED SILICAS BY ELECTRODIALYSIS

(75) Inventors: Patrik Stenner, Hanau (DE); Florian Zschunke, Frankfurt am Main (DE); Juergen Behnisch, Rheinbach (DE); Markus Ruf, Alfter-Witterschlick (DE); Manfred Dannehl, Kahl am Main (DE); Silke Suhr, Albstadt-Alzenau (DE)

(73) Assignee: EVONIK DEGUSSA GmbH, Essen (DE)

(21) Appl. No.: 13/202,512

(22) PCT Filed: Mar. 11, 2010
(86) PCT No.: PCT/EP2010/053098

§ 371 Date: Aug. 19, 2011

(30) Foreign Application Priority Data
Mar. 12, 2009 (DE) 10 2009 001 512.4

(51) Int. Cl. C01B 33/12; B24B 1/00; C09K 3/14; B01D 61/42; C09D 1/00; D21H 19/00

(52) U.S. Cl. 51/308; 106/286.8; 106/286.3; 162/135; 204/518; 204/627; 451/36; 423/335

(57) ABSTRACT

The present invention relates to suspensions which have a very low salt content and contain at least one precipitated silica, a process for producing them and also their use.

The present invention relates to suspensions which have a very low salt content and contain at least one precipitated silica, a process for producing them and also their use.

Precipitated silicas are produced by reacting alkali metal and/or alkaline earth metal silicates with acidifying agents such as hydrochloric acid, sulphuric acid, nitric acid, phosphoric acid or CO₂. This forms not only the desired precipitated silica but also a large amount of inorganic salts which have to be separated off from the precipitated silica. For many applications, e.g. as filler in elastomers, it is sufficient to wash the precipitated silica with water in order to remove most of the salts. However, for some applications in which the precipitated silicas are used, for example, as suspension, the salt content has to be very low, as a result of which the outlay for purification is significantly increased. Here too, the purification of the particles is usually attempted by conventional washing. These washing processes are based on the principle of nonideal displacement washing, and the washing water consumption is therefore very high in the case of a very high degree of purification down to the lower ppm range.

For other applications such as chemical wafer polishing the salt content of the silica suspensions has to meet even more demanding requirements since no impurities are allowed to be passed to the wafer. This field of application has therefore not hitherto been available to precipitated silicas.

Various proposals for carrying out the removal of salt impurities by means of electrodialysis in order to purify silica sols have been put forward. Thus, for example, JP 2001072409 describes processes in which water glass is passed over ion-exchange resins to form a silica sol. This silica sol is in turn purified by means of electrodialysis. The process described here is very complicated since a plurality of electrodialyses sometimes have to be carried out. Furthermore, these processes are not comparable with purification processes for precipitated silica suspensions since in the production of silica sols the water glass is reacted with an ion-exchange resin and not with an acid, so that the salt burden in the sol is significantly lower from the beginning.

EP 1 353 876 B1 proposes a process in which a sol is produced by reaction of water glass with diluted acids. Directly after the reaction of the water glass with the acid, the sol formed is purified and freed of inorganic salts by means of electrodialysis. This process is very complicated and requires special apparatuses since the electrodialysis is carried out directly after the reaction of water glass with acid. Furthermore, this process is only suitable for silica sols having a low degree of aggregation and agglomeration. Such sol particles are very small and have a small proportion of internal voids, so that only little, if any, salt is incorporated in the interior of the particles. The situation is different in the case of precipitated silica suspensions since aggregates and agglomerates in the interior of which, e.g. in internal voids, incorporated salts are present are formed during the production of precipitated silicas. The process of EP 1 353 876 B1 can thus not be used for producing suspensions containing precipitated silicas.

There is thus still a great need for simple and effective processes for producing precipitated silica suspensions having a very low salt content. In particular, there is a need for an effective process for purifying suspensions which have a high proportion of silica aggregates and agglomerates and thus have a high proportion of salts incorporated in interior voids.

It was therefore an object of the present invention to provide a novel process for producing suspensions which have a very low salt content and contain at least one precipitated silica, which process does not have at least some of the disadvantages of the processes of the prior art or has them to a reduced extent. Furthermore, it was an object of the present invention to provide suspensions which have a low salt content and contain at least one precipitated silica.

A specific object of the present invention was to provide suspensions which contain at least one precipitated silica and have a content of sodium sulphate of less than 1000 ppm and also an effective process for producing them.

A further specific object of the present invention was to provide suspensions which contain at least one precipitated silica and have a total content of calcium, iron and magnesium of less than 400 ppm and also an effective process for producing them.

Further objects which are not explicitly mentioned can be derived from the total context of the description, drawings, examples and claims.

These objects are achieved by the process described in more detail in the description, the examples and the claims and also the suspensions described in more detail there.

The inventors of the present invention have surprisingly discovered that it is possible to reduce the sulphate content of suspensions containing at least one precipitated silica simply and effectively to below 1000 ppm, preferably below 500 ppm, when the pH of the suspension containing at least one precipitated silica is set to less than or equal to 5 and an electrodialysis is carried out in a specific electrodialysis apparatus which allows very high potentials to be built up. It has been found that precisely these high potentials and the pH of the suspension are necessary to solve the problem of the salts enclosed in the precipitated silica particles. Without wishing to be tied to a particular theory, the inventors believe that the high potential results in the ions being drawn out from the interior of the silica particles, even through very narrow pores or along a pore network.

In contrast to the processes of the prior art in which the salts are separated off by washing of the silica, the process of the invention is not based on infinite dilution of the washing water. Instead, the salt ions are selectively transferred into a second chamber of the electrodialysis cell which is separate from the product chamber. In this “electrochemical washing”, the salt concentration is always close to zero since salts present in dissociated form are immediately transferred to a second chamber by the high electric field. Particularly in the case of highly porous materials having a large internal surface area, it is necessary to build up a high concentration difference between the interior of the particle and the outer shell of water in order that sufficient mass transfer of the salt to the outside takes place. A further advantage of the process is the low washing water consumption. The impurities accumulate in the anolyte and catholyte.

In contrast to the process of EP 1 353 876 B1, the process of the invention has the advantage that precipitated silica suspensions can firstly be produced in conventional production plants and only the finished suspension is purified. It is therefore not necessary to divert streams of material directly after the reaction of water glass with acid and construct new precipitation vessels for this purpose.

The suspensions produced by the process of the invention are storage-stable, which is achieved, inter alia, by the pH. A further advantage which is attributable, inter alia, to the low pH is that the suspensions according to the invention have a low viscosity and can thus be readily processed. Without wishing to be tied to a particular theory, the inventors believe that a hydration shell is formed around the silica particles at the pH values selected and this hydration shell reduces the viscosity.

The electrodialysis apparatus of the invention has the advantage over apparatuses known hitherto that it has an increased electrode spacing. Without wishing to be tied to a particular theory, the inventors believe that this makes optimized turbulent flow of the suspension and thus optimal removal of the anions possible.

The high removal of the anions is brought about by the high potential. This high potential can only be employed since the product region of the electrodialysis cell of the invention is separated from the catholyte region by a cation-exchange membrane.

The present invention accordingly provides a process for producing suspensions which have a low salt content and contain at least one precipitated silica, which comprises the following steps:
a. provision of a suspension containing at least one precipitated silica
b. adjustment of the pH of the suspension to a value in the range from 0.5 to 5 if the suspension from step a. does not already have a pH in this range
c. purification of the suspension by means of electrodialysis, where
   i. the electrodialysis apparatus comprises one or more electrodialysis cell(s) which is/are configured so that the product region(s) is/are separated from the catholyte region(s) by a/in each case a cation-exchange membrane and the electrode spacing is from 2 mm to 200 mm,
   ii. a potential of from 5 to 1000 volt is applied.

The present invention further provides suspensions which have a low level of salt impurities and contain at least one precipitated silica as defined in more detail in the following description and the claims.

The present invention further provides electrodialysis cells comprising in each case an anode, an anolyte region which is separated from the product region by a diaphragm and/or an anion-exchange membrane and/or another suitable membrane, a catholyte region and a cathode, which are characterized in that
a cation-exchange membrane is located between the product region and the catholyte region and
the spacing of the electrodes is from 2 mm to 200 mm.

The present invention likewise provides electrodialysis apparatuses comprising at least one electrodialysis cell according to the invention.

Finally, the present invention provides for the use of the suspensions of the invention for producing inkjet coatings and also in the field of CMP (chemical mechanical polishing) and also for producing dried precipitated silicas having a low content of salt impurities.

The invention is illustrated in detail below, with the terms resuspension and fluidization and the terms precipitated silica suspension and suspension containing at least one precipitated silica being used synonymously in each case.

The process of the invention for producing suspensions which have a low salt content and contain at least one precipitated silica comprises the following steps:
a. provision of a suspension containing at least one precipitated silica
b. adjustment of the pH of the suspension to a value in the range from 0.5 to 5 if the suspension from step a. does not already have a pH in this range
c. purification of the suspension by means of electrodialysis, where
   i. the electrodialysis apparatus comprises one or more electrodialysis cell(s) which is/are configured so that the product region(s) is/are separated from the catholyte region(s) by a/in each case a cation-exchange membrane and the electrode spacing is from 2 mm to 200 mm in each case,
   ii. a potential of from 5 to 1000 volt is applied.

The suspension in step a. can be a precipitation suspension, i.e. a suspension as is obtained by reacting alkali metal and/or alkaline earth metal silicates with acidifying agents. However, it can also be a resuspended filter cake. The precipitation suspension is filtered by conventional methods known to those skilled in the art and preferably washed with water and/or distilled water and/or deionized water. This process offers the advantage that a major part of the salts present in the precipitation suspension is washed out before the electrodialysis and the suspension obtained has a lower salt burden when it is subjected to electrodialysis. The suspension as per step a. can also be produced by resuspending a previously dried precipitated silica. Such dried precipitated silicas are usually likewise washed before drying, so that the salt content is reduced. The dried precipitated silica can be used in powder, granular or microgranular form. Microgranular means that the precipitated silica is present in the form of essentially spherical granules. To resuspend filter cakes or dried precipitated silicas, it can be necessary to use shear aggregates and/or to add an acidifying agent. Such techniques for producing suspensions containing at least one precipitated silica are known to those skilled in the art, e.g. from DE 2447613.

Finally, any mixed forms are also possible. Thus, for example, a previously dried precipitated silica can be mixed with a filter cake and resuspended or a filter cake is mixed with a precipitation suspension. These mixed forms make it possible to optimize the property profile of the suspension and thus combine the properties of a plurality of, for example, different precipitated silicas. Similar effects can be achieved by adding fumed silicas or silica gels or silica sols to the suspension in step a. Fumed silicas have a different nature of the surface and a low salt content as a result of the completely different production process, so that very special property profiles can be created by combining precipitated silicas and fumed silicas in a suspension. However, preference is given to using suspensions consisting of one or more precipitated silica(s), the dispersion medium, preferably water and/or distilled water and/or deionized water and/or an acidifying agent, and the salts to be separated off in the process of the invention.

The salts to be separated off in the process of the invention comprise salts formed in the precipitation reaction, salts which have been added as electrolyte before or during the precipitation reaction and/or other undesirable inorganic or organic salts present in the suspension as per step a., e.g. salts which were originally present as impurities in the starting materials for the precipitation reaction or in the dispersion medium.

To produce the suspension as per step a. of the process of the invention, preference is given to using water, particularly preferably distilled water or deionized water. It is also possible to use an acidifying agent selected from the group consisting of hydrochloric acid, phosphoric acid, sulphuric acid and nitric acid in place of the water or together with the abovementioned water. If a fluidization step is necessary here, the mechanical energy required for fluidization can be reduced by addition of acid or addition of aluminates. Since polyvalent anions in particular interfere in many applications (these “conglutinate” the cationized precipitated silica particles, leading to undesirable coagulation/agglomeration), preference is given to using acids having monovalent anions. In a specific case, the addition of acid is omitted in order to avoid introducing even more ions into the suspension and having to remove them again later.

The precipitated silicas present in the suspension according to the invention can be produced by any processes and can have a property profile tailored to the planned field of application. Examples of such silicas may be found in the product brochure “Sipernat—Performance Silica” of Degussa AG, November 2003. Precipitated silicas from other manufacturers, for example W. R. Grace & Co., Rhodia Chimie, PPG Industries, Nippon Silica, Huber Inc., can of course likewise be used.

Depending on the pH at which the precipitation is carried out or the pH of the precipitated silica used, the pH of the suspension from step a. is set to a value of from 0.5 to 5, preferably from 0.5 to 4, particularly preferably from 1 to 4, very particularly preferably from 1.5 to 3 and especially preferably from 2.5 to 3, in step b. This can, depending on the pH of the suspension from step a., be effected by addition of an acidifying agent or a base.

Preference is given to using hydrochloric acid as acidifying agent. The setting of the pH to the range mentioned is important to ensure sufficient stability of the suspension. Furthermore, the viscosity of the suspension is adjusted thereby.

In step c., the suspension is purified by means of electro-dialysis, with the electrodialysis being carried out in, depending on the amount of suspension to be purified, one or more cell/cells which each consist of three chambers. The product is passed through the middle chamber, the product region. The anolyte and the catholyte are passed through the two outer chambers, viz. the anolyte region and the catholyte region, respectively. The product region is separated from the catholyte region by means of a cation-exchange membrane, preferably a sulphonated cation-exchange membrane. The cation-exchange membrane allows only cations to pass through and is impermeable to particles and anions.

The anolyte region is separated from the product chamber by a diaphragm or an ion-exchange membrane or another suitable membrane, e.g. a separator from membrane technology. The pore opening of the membranes or of the diaphragm is preferably selected so that it is smaller than the particle size of the particles to be purified, so that no particles can go over into the anolyte region. The pore opening is therefore preferably from 5 nm to 10 μm, in particular from 10 nm to 5 μm, particularly preferably from 20 nm to 1 μm, very particularly preferably from 50 nm to 500 nm and especially preferably from 50 nm to 250 nm.

The electrode material is not particularly critical and it is in the present case possible to use all electrodes which are customarily used in electrodialysis. As cathode, it is possible to use, for example, a lead sheet, graphite or stainless steel (1.4539) (cathodically stable material), and as anode it is possible to use a platinum sheet, a platinum-coated metal sheet, diamond or DSA®, i.e. dimensionally stable anodes (mixed oxide). However, the spacing of the electrodes, which is in the range from 2 mm to 200 mm, preferably from 6 mm to 80 mm, particularly preferably from 10 mm to 50 mm, especially preferably from 10 mm to 40 mm and very especially preferably from 10 mm to 30 mm, is critical. This is important to prevent blockages of the cell and to ensure turbulent flow during operation of the cell.

The cell/cells is/are operated with a potential of from 5 to 1000 volt, preferably from 10 to 500 volt, particularly preferably from 10 to 200 volt, very particularly preferably from 20 to 150 volt, being applied. A very high potential ensures a high potential gradient and thus a high concentration difference between the interior of the particle and the outer water shell. This leads to rapid outward transport of the salts and to a high rate of removal of the anions and cations. The inventors have discovered that this high potential is necessary, particularly in the case of suspensions containing precipitated silicas, to be able also to remove the ions present in the interior of the particles effectively. However, the high potentials require the above-described specific construction of the cell/cells, i.e. the cation-exchange membrane and the suitable electrode spacing. Particularly at very high potentials, sulphonated cation-exchange membranes are particularly preferred.

The anolyte region can be separated from the product region by means of anion-exchange membranes or diaphragms or other separators, for example ceramics and sintered metals, with diaphragms being preferred.

The respective chamber(s) of the electrodialysis cell(s) is/are preferably configured so that turbulent flow is established. For this purpose, turbulence promoters, for example woven PE meshes having a mesh opening of 5 mm and a material thickness of 1 mm, are, in a preferred embodiment, present in the two outer chambers, i.e. the anolyte region and the catholyte region. On the other hand, turbulence promoters are preferably dispensed with in the product region in order to prevent blockages. Optimized turbulent flow of the three streams can improve mass transfer at the phase boundary and the stability of the membranes/separators.

The above-described electrodialysis cell(s) is/are preferably part of an electrodialysis apparatus. The electrodialysis apparatus comprises, in addition to the electrodialysis cells, three circuits, viz. the product circuit, the anolyte circuit and the catholyte circuit. The suspension is circulated by means of suitable pumps during the electrodialysis. The anions accumulate in the anolyte and the cations accumulate in the catholyte. Depending on the dimension of the process and the amount of suspension to be purified, the apparatus can have a plurality of electrodialysis cells according to the invention together with the corresponding circuits.

The process of the invention is preferably carried out by pumping anolyte, catholyte and the precipitated silica suspension through the electrodialysis apparatus, in each case in a circulation system, with anolyte and catholyte particularly preferably being conveyed in countercurrent to the precipitated silica suspension. The countercurrent mode of operation enables the purifying action to be improved further. However, it should be ensured that the pressure in the anolyte region is less than or equal to the pressure in the product region in order to prevent backmixing. In this context, it should also be ensured that the anion concentration in the anode chamber does not become too high since otherwise backdiffusion can take place. This can be achieved, for example, by the anolyte being completely or partly replaced from time to time by fresh anolyte.

In a preferred embodiment, the cell(s) is/are supplied with direct current by means of a current source and is/are very particularly preferably operated potentiostatically at the abovementioned potentials.

In a further preferred embodiment, the process is operated with the pH of the suspension being kept constant during the course of the electrodialysis so that it fluctuates by not more than ±0.3 about the pH at the beginning of the electrodialysis and/or at the end of the electrodialysis is not more than 25%, preferably not more than 15%, below the initial value at the beginning of the electrodialysis. For this purpose, the pH is preferably monitored continuously, e.g. by means of a pH electrode, during the electrodialysis and is, if appropriate, adjusted by addition of acid or base.

In the process of the invention, preference is given to using water, distilled water or deionized water and/or NaOH as catholyte. Suitable anolytes are, in particular, water or distilled water or deionized water. To improve the conductivity, it is possible to add electrolyte salts or acids, preferably ones having monovalent anions, e.g. HNO₃ or HCl.

Depending on the intended use, the precipitated silica or the precipitated silica suspensions can be subjected to a milling step during the course of the process. Here, the milling of the precipitated silica particles can be carried out before step a) and/or between steps a) and b) and/or between steps b) and c) and/or after step c). The milling is preferably carried out after step c). The milling can be carried out as dry milling, before step a, or as wet milling, during or after step a. Suitable milling processes and apparatuses are known to those skilled in the art and information on them can be found, for example, in Ullmann, 5th edition, B2, 5-20. Preference is given to using impact mills or opposed jet mills for dry milling. Wet milling is preferably carried out by means of ball mills, e.g. stirred ball mills or planetary ball mills, or by means of high-pressure homogenizers. The milling parameters are preferably selected so that the purified and milled product has an average particle size d₅₀ of from 100 nm to 10 μm, preferably from 100 nm to 5 μm, particularly preferably from 100 nm to 1 μm, very particularly preferably from 100 nm to 750 nm, especially preferably from 100 nm to 500 nm and very especially preferably from 150 nm to 300 nm, at the end of the process.

In a further preferred embodiment of the process of the invention, the precipitated silica particles which have been substantially freed of salts by the process of the invention and have optionally been milled can be brought into contact with a surface-modifying agent, e.g. p-DADMAC.

The suspensions which can be obtained by the process of the invention are characterized in that they comprise at least one precipitated silica and have a low content of sulphur-containing compounds. The content of sodium sulphate in particular is preferably very low. In a further preferred embodiment of the present invention, the total content of calcium, iron and magnesium in the suspensions is particularly low. This is advantageous since precisely these elements form stable salts with polyvalent anions such as sulphate and phosphate ions.

The total content of sulphur-containing compounds in the suspensions of the invention is preferably less than 0.02 [% g/g], more preferably less than 0.015 [% g/g] and especially preferably less than 0.01 [% g/g], in each case based on dried precipitated silica.

In a preferred embodiment, the suspensions of the invention have a sodium sulphate content of less than or equal to 1000 ppm, preferably less than or equal to 500 ppm, particularly preferably less than or equal to 500 ppm, very particularly preferably less than or equal to 200 ppm, especially preferably less than or equal to 100 ppm, very especially preferably less than 80 ppm, in particular less than 60 ppm, even more particularly preferably less than 20 ppm, even much more preferably less than or equal to 10 ppm and most preferably from 0.001 to 0.8 ppm.

In a further preferred embodiment, the total content of calcium, iron and magnesium in the suspensions of the invention, based on dried substance, is less than 400 ppm, preferably from 1 ppm to 350 ppm, particularly preferably from 10 ppm to 300 ppm and very particularly preferably from 50 ppm to 260 ppm.

Since, in particular, polyvalent anions interfere in many applications, for example in the field of absorption of liquid media, e.g. in the field of ink jet printing, because these “conglutinate” the silica particles and thus lead to agglomerate formation, the total content of multivalent anions in the suspensions of the invention is preferably very low. In a specific embodiment, it is less than 50 ppm, preferably 20 ppm, particularly preferably 0.0001 and 10 ppm and very particularly preferably from 0.001 to 5 ppm.

The precipitated silica particles in the suspensions of the invention preferably have an average particle size d₅₀ of from 100 nm to 10 μm and when used for producing paper coatings therefore ensure that a sufficiently small droplet size is achieved in ink absorption.

For specific applications, e.g. ink jet media, the precipitated silica particles in the suspension of the invention can be coated with a surface-modifying agent, preferably a polyelectrolyte, particularly preferably p-DADMAC.

As indicated above in the description of the process, the suspensions of the invention can also comprise more than one precipitated silica and/or fumed silica and/or a silica gel. In this way, the properties of the suspensions of the invention can be matched very well to the requirements of the respective field of application. However, the suspensions of the invention preferably contain only SiO₂ in the form of one or more precipitated silica(s) and very particularly preferably only one precipitated silica together with the dispersion medium and the residual amounts of salt impurities.

It is possible to produce highly pure precipitated silicas having a very low proportion of salt impurities by drying of the purified suspensions. Here, it is in principle possible to employ any drying method known to those skilled in the art, e.g. in a flow dryer, spray dryer, rack dryer, belt dryer, rotary tube dryer, flash dryer, spin-flash dryer or nozzle tower dryer. These drying variants include operation using an atomizer, a one-fluid or two-fluid nozzle or an integrated fluidized bed. Spray drying can be carried out, for example, as described in U.S. Pat. No. 4,094,771. Nozzle tower drying can be carried out, for example, as described in EP 0937755. The spray-dried particles can have average diameters of above 15 μm, preferably from 15 to 80 μm, measured by means of laser light scattering. The nozzle-tower-dried particles preferably have average particle sizes, measured by means of sieve analysis (Alpine), of above 80 μm, in particular above 90 μm, preferably above 200 μm.

The suspensions of the invention can be used for producing paper coatings for ink jet recording media and/or in the field of chemical mechanical polishing.

### Measurement Methods

1) pH of the suspension
   The pH of the suspension is determined by known methods by means of a previously calibrated combination electrode.
2) Determination of the total sulphur content by means of hot carrier gas extraction
   The determination of the sulphur content is carried out by means of hot carrier gas extraction on a LECO analyser SC 144 DR.
   For the analysis, about 250 mg of the untreated sample are weighed into a ceramic boat. The sample is burnt under a stream of oxygen in an electric resistance furnace. The sulphur present in the sample is oxidized to sulphur dioxide which, after various purification steps in the analyser, is quantified by means of an infrared detector.
3) Determination of the sodium sulphate content
   The samples were centrifuged. The supernatant liquid was diluted with distilled water by a factor of, depending on sulphate concentration, from 1:10 to 1:200. The diluted solution was filtered. The sulphate content was determined by ion chromatography. The sodium sulphate content is then calculated from the sulphate content.
4) Determination of the total content of calcium, iron and magnesium
   The determination of the total content of calcium, iron and magnesium is carried out by means of ICP-MS. The results are based on dried material. The determination of the loss on drying is therefore firstly determined by weighing about 25 g of sample material, evaporating this at 95° C. on a hotplate and then drying it to constant weight at 105° C. in a drying oven.
   To determine the content of calcium, iron and magnesium, about 25 g of sample material are then weighed into a platinum dish and asked with addition of concentrated sulphuric acid and hydrofluoric acid at 450° C. in a muffle furnace over a number of hours. The ash residue is dissolved in concentrated sulphuric acid, transferred to a polypropylene test tube and made up with high-purity water. To carry out a duplicate determination, two of these digestions can be carried out on each sample.
   The sample solutions are diluted with dilute nitric acid in a polypropylene test tube. In addition, blank solutions and also various calibration solutions from multielement stock solutions are prepared. The element indium is additionally added as internal standard to all blank, calibration and sample solutions. The element contents in the blank, calibration and sample solutions prepared in this way are measured by means of high-resolution inductively coupled plasma mass spectrometry (HR-ICPMS) at a mass resolution (m/Δm) of 4000 or 10 000 for the elements arsenic and selenium and quantified by means of external calibration.
5) Determination of the average particle size of the silica particles
   The determination of the average particle size d₅₀ of the high-purity silicon dioxides is carried out using a Coulter LS 230 laser light scattering instrument.

### DESCRIPTION

The use of laser light scattering according to the Fraunhofer model for determining particle sizes is based on the phenomenon that particles scatter monochromatic light with a different intensity pattern in all directions. This scattering is dependent on the particle size. The smaller the particles, the higher the scattering angles. In the case of particle sizes of less than 1 μm, the evaluation is carried out using the Mie theory.

### Procedure:

The Coulter LS 230 laser light scattering instrument requires a warming up time of from 1.5 to 2.0 hours after switching on in order to obtain constant measured values. The sample has to be shaken up very well before the measurement. The program “Coulter LS 230” is firstly started with a double click. Here, it has to be ensured that “Optische Bank benutzen” is activated and the display on the Coulter instrument shows “Speed off”. Press the button “Drain” and keep this pressed until the water in the measurement cell has run away, subsequently press the button “On” on the fluid transfer pump and likewise keep it pressed until the water runs into the overflow on the instrument. Carry out this operation a total of two times. Subsequently press “Fill”. The program starts automatically and removes any air bubbles from the system. The speed is automatically increased and reduced again. The pump power selected for the measurement has to be set. Before the measurement, it has to be decided whether the measurement is to be carried out with or without PIDS. To start the measurement, “Messung”, “Messzyklus” is selected.
a) Measurement without PIDS
   The measurement time is 60 seconds, the delay time is 0 second. The calculation model on which the laser light scattering is based is subsequently selected.
   A background measurement is carried out automatically before each measurement. After the background measurement, the sample has to be introduced into the measurement cell until a concentration of from 8 to 12% has been reached. The program signals this by displaying “OK” in the upper part. Finally, click on “Fertig”. The program then carries out all necessary steps automatically and after the measurement is concluded generates a particle size distribution of the sample examined.
b) Measurement using PIDS
   Measurements using PIDS are carried out when the expected particle size distribution is in the submicron range.
   The measurement time is 90 seconds, the delay time is 0 second. The calculation model on which the laser light scattering is based is subsequently selected.
   A background measurement is carried out automatically before each measurement. After the background measurement, the sample has to be introduced into the measurement cell until a concentration of at least 45% has been reached. The program signals this by displaying “OK” in the upper part. Finally, click on “Fertig”. The program then carries out all necessary steps automatically and after the measurement is concluded generates a particle size distribution of the sample examined.

The following examples serve merely to aid better understanding of the present invention but do not restrict it in any way.

### Example 1

500 ml of a suspension comprising 20% by weight of precipitated silica (Ultrasil 7000) and having a pH of 4 were placed in an electrodialysis apparatus comprising three circuits, viz. the product circuit, the anolyte circuit and the catholyte circuit, and an electrodialysis cell. The initial sodium sulphate content of the suspension was 800 ppm. As anolyte and catholyte, in each case about 500 ml of deionized water were placed in the apparatus. The suspension and solutions were circulated by means of suitable pumps so that the product stream flowed through the electrodialysis cell in countercurrent to the anolyte and catholyte streams. The electrodialysis cell comprised three chambers, with turbulence promoters, as described above in the description, being installed in the two outer chambers. The product was passed through the middle chamber and the anolyte and catholyte, respectively, were passed through the two outer chambers. The product chamber was separated from the catholyte by a cation-exchange membrane (DuPont, Nafion 450). The anolyte was separated from the product chamber by a diaphragm having a pore opening of about 100 nm. A lead sheet was used as cathode and a platinum foil was used as anode. The electrode area is 100 cm². The electrode spacing was 30 mm. To protect against H₂O₂ explosions, all vessels were blanketed with nitrogen. The pressure in the product chamber was regulated so that the pressure in the anolyte chamber was no higher than that in the product chamber in order to prevent backmixing. The cell was supplied potentiometrically with direct current by means of a power source and operated at 75V. Two hours after commencement of the electrodialysis, the sodium sulphate concentration of the suspension was about 50 ppm, the current rose from about 0.01 A to 0.05 A. The pH dropped to 3.5.

### Example 2

500 ml of a suspension comprising 16% by weight of precipitated silica (Sipernat 200) and having a pH of 3.3 were placed in an electrodialysis apparatus comprising three circuits, viz. the product circuit, the anolyte circuit and the catholyte circuit, and an electrodialysis cell. The initial sodium sulphate content of the suspension was 450 ppm. As anolyte and catholyte, in each case about 500 ml of deionized water were placed in the apparatus. The suspension and solutions were circulated by means of suitable pumps so that the product stream flowed through the electrodialysis cell in countercurrent to the anolyte and catholyte streams. The electrodialysis cell comprised three chambers, with turbulence promoters, as described above in the description, being installed in the two outer chambers. The product was passed through the middle chamber and the anolyte and catholyte, respectively, were passed through the two outer chambers. The product chamber was separated from the catholyte by a cation-exchange membrane (DuPont, Nafion 450). The anolyte was separated from the product chamber by a diaphragm having a pore opening of about 100 nm. A lead sheet was used as cathode and a platinum foil was used as anode. The electrode area is 100 cm². The electrode spacing was 30 mm. To protect against H₂O₂ explosions, all vessels were blanketed with nitrogen. The pressure in the product chamber was regulated so that the pressure in the anolyte chamber was no higher than that in the product chamber in order to prevent backmixing. The cell was supplied potentiometrically with direct current by means of a power source and operated at 75V. 75 minutes after commencement of the electrodialysis, the sodium sulphate concentration of the suspension was about 50 ppm, the current rose from about 0.01 A to 0.05 A. The pH dropped to 3.1. The content of important impurities in the dispersions according to the invention is shown in Table 1 below:

TABLE 1

| | Before | |
|---|---|---|
| | commencement | After commencement |
| | of the | of the |
| Impurity | electrodialysis | electrodialysis |
| Sulphur content | 0.039 ± 0.002 | 0.009 ± 0.002 |
| [% g/g] | | |
| Calcium [ppm] | 230 | 55 |
| Iron [ppm] | 140 | 130 |
| Magnesium [ppm] | 90 | 70 |

1. A process for producing a suspension comprising:
a) adjusting the pH of a first suspension comprising at least one precipitated silica to a value in the range from 0.5 to 5 if the first suspension does not already have a pH in this range; and
b) purifying the first suspension by electrodialysis with an electrodialysis apparatus,
wherein:
the electrodialysis apparatus comprises at least one electrodialysis cell configured so that at least one product region is separated from at least one catholyte region by a cation-exchange membrane and an electrode spacing is from 2 mm to 200 mm;
a potential from 5 to 1000 volts is applied; and
the suspension comprises at least one precipitated silica.

2. The process of claim 1, wherein the first suspension is a precipitation suspension obtained:
(i) directly by reaction of an alkali metal silicate and an alkaline earth metal silicate with at least one acidifying agent; or
(ii) by liquefaction of:
(a) a filter cake; or
(b) a suspension obtained by washing and liquefaction of a filter cake.

3. The process of claim 1, wherein the first suspension is obtained by suspending pulverulent, granular or microgranular precipitated silica in a dispersion medium.

4. The process of claim 1, wherein the electrodialysis is carried out such that an anolyte, a catholyte and the first suspension are pumped in a circuit system through the electrodialysis cell.

5. The process of claim 4, wherein the process is carried out such that a turbulent flow is established in at least one region selected from the group consisting of the product region, at least one anolyte region, and the catholyte region.

6. The process of claim 1, wherein a pressure in at least one anolyte region is less than or equal to a pressure in the product region.

7. The process of claim 1, wherein the at least one product region is, in each case, separated from at least one anolyte region by at least one barrier selected from the group consisting of an anion-exchange membrane and a diaphragm.

8. The process of claim 7, wherein the diaphragm has a pore opening of from 5 nm to 10 μm.

9. The process of claim 1, wherein a pH of the first suspension is held constant during the electrodialysis such that:
(a) the pH fluctuates by no more than ±0.3 from the pH at the beginning of the electrodialysis; and
(b) the pH at the end of the electrodialysis is no more than 25% below the pH at the beginning of the electrodialysis.

10. The process of claim 1, wherein:
a lead, graphite or stainless steel electrode is used as a cathode, and
a platinum, a platinum-coated metal, or diamond electrode, or a dimensionally stable anode, is used as an anode.

11. The process of claim 1, wherein at least one milling step is carried out during at least one time selected from the group consisting of:
before suspending the at least one precipitated silica;
between the suspending of the at least one precipitated silica and the adjusting the pH of the first suspension a);
between the adjusting the pH of the first suspension a) and the purifying the first suspension b);
after the purifying the first suspension b).

12. The process of claim 11, wherein the process is controlled such that particles of the precipitated silica in the first suspension have an average particle size, d₅₀, of from 100 nm to 10 μm at the end of the process.

13. The process of claim 1, further comprising contacting the precipitated silica with a surface-modifying agent.

14. A suspension, comprising at least one precipitated silica, wherein the suspension has a sodium sulphate content less than or equal to 1000 ppm.

15. A suspension, comprising at least one dried precipitated silica, wherein the suspension has less than 0.02 [% g/g] of sulphur-containing compounds, based on the dried precipitated silica.

16. The suspension of claim 14, wherein the suspension has a total content of calcium, iron and magnesium of less than 400 ppm, determined by ICP-MS.

17. The suspension of claim 14, wherein particles of the precipitated silica have an average particle size, d₅₀, of from 100 nm to 10 μm.

18. The suspension of claim 14, wherein at least part of the particle surface of the precipitated silica has been coated with a surface-modifying agent.

19. A precipitated silica suspension obtained by the process of claim 1.

20. A method for producing paper coatings, comprising coating a paper with the suspension of claim 14.

21. An electrodialysis cell, comprising
an anode, an anolyte region, a catholyte region, a cathode, and a product region,
wherein:
the anolyte region is separated from the product region by at least one barrier selected from the group consisting of a diaphragm, an anion exchange membrane, and another membrane;
a cation-exchange membrane is present between the product region and the catholyte region; and
an electrode spacing is from 2 mm to 200 mm.

22. The electrodialysis cell of claim 21, further comprising at least one turbulence promoter in the anolyte region and in the catholyte region.

23. The electrodialysis cell of claim 21, further comprising a sulfonated cation-exchange membrane.

24. An electrodialysis apparatus, comprising at least one electrodialysis cell of claim 21.

25. The electrodialysis apparatus of claim 24, wherein an anolyte and a catholyte are conveyed through the electrodialysis apparatus in countercurrent to a product stream.

26. The process of claim 1, wherein the first suspension is a precipitation suspension obtained:
(i) directly by reaction of an alkali metal silicate or an alkaline earth metal silicate with at least one acidifying agent; or
(ii) by liquefaction of:
(a) a filter cake; or
(b) a suspension obtained by washing and liquefaction of a filter cake.

27. The process of claim 3, wherein the dispersion medium is at least one selected from the group consisting of water, distilled water, deionized water, and an acidifying agent.

28. The process of claim 27, wherein the first suspension is obtained under the action of shear forces.

29. The process of claim 4, wherein the anolyte and the catholyte are conveyed in countercurrent to the first suspension.

30. The process of claim 1, wherein a pH of the first suspension is held constant during the electrodialysis such that:
(a) the pH fluctuates by no more than ±0.3 from the pH at the beginning of the electrodialysis; or
(b) the pH at the end of the electrodialysis is no more than 25% below the pH at the beginning of the electrodialysis.

31. The method of claim 20, wherein the method produces paper coatings for ink jet recording media.

32. A method for chemical mechanical polishing, comprising polishing an article with the suspension of claim 14.

33. A method for producing dried precipitated silicas, comprising drying and precipitating the suspension of claim 14.

34. The process of claim 1, wherein a salt content of the suspension is:
about 50 ppm of sodium sulphate, as determined by ion chromatography;
55 ppm of calcium, as determined by ICP-MS;
130 ppm of iron, as determined by ICP-MS; and
70 ppm of magnesium, as determined by ICP-MS.
